(19) United States
(12) Patent Application Publication
(10) Pub. No.: US 2026/0274080 A1
(43) Pub. Date: Sep. 17, 2026

(54) Voltage Supply Device for a Motor Vehicle; Motor Vehicle and Manufacturing Method for a Voltage Supply Device

(71) Applicant: Bayerische Motoren Werke Aktiengesellschaft, Muenchen (DE)

(72) Inventors: David BOCK, Pastetten (DE); Christopher VON KUENSBERG SARRE, Muenchen (DE)

(21) Appl. No.: 19/567,771

(22) Filed: Mar. 16, 2026

(30) Foreign Application Priority Data
Mar. 17, 2025 (DE) 10 2025 110 134.5

(51) Int. Cl. B60L 15/00; H02M 7/00; H02M 7/5387

(52) U.S. Cl. CPC B60L 15/007; H02M 7/003; H02M 7/5387; B60L 2210/42

(57) ABSTRACT

A voltage supply device for a motor vehicle includes at least one carrier plate on which a half-bridge circuit is arranged, which comprises a high-side switch and a low-side switch, each of which comprises at least one switchable semiconductor chip. On the carrier plate, a plurality of chip positions are arranged for the high-side switch 6) and the low-side switch, each of which can be occupied by exactly one semiconductor chip, wherein a number of occupied chip positions depends on a predetermined current strength for an output current of the voltage supply device. The disclosure also relates to a motor vehicle with the voltage supply device, and to a method of manufacturing the voltage supply device.

### CROSS-REFERENCE TO RELATED APPLICATION

This application claims priority under 35 U.S.C. §119 from German Patent Application No. 10 2025 110 134.5, filed March 17, 2025, the entire disclosure of which is herein expressly incorporated by reference.

### BACKGROUND AND SUMMARY

The present disclosure relates to a voltage supply device for a motor vehicle. The voltage supply device has at least one carrier plate on which a half-bridge circuit is arranged. The half-bridge circuit comprises a high-side switch and a low-side switch, each of which comprises at least one switchable semiconductor chip. The present disclosure also relates to a motor vehicle with such a voltage supply device and a manufacturing method for such a voltage supply device.

A motor vehicle may comprise at least one voltage supply device, such as an inverter, a DC-DC converter, or another device designed to supply a predetermined voltage to at least one consumer in the motor vehicle. For example, the inverter may be designed to convert a DC voltage supplied by an energy storage device of the motor vehicle into an AC voltage required by the at least one consumer, such as a drive device of the motor vehicle in the case of an electric vehicle and/or a hybrid vehicle, and to supply the generated AC voltage to the motor vehicle.

The voltage supply device may be based on a half-bridge circuit for supplying the desired voltage, which has two switches and is designed to switch the two switches on alternately. The two switches are typically referred to as high-side switches and low-side switches.

DE 10 2022 207 899 A1 shows a power semiconductor module with at least three phases, associated current connections, and at least one printed circuit board. For each phase, the power semiconductor module has a semiconductor package arranged below the current connections, which has at least two lateral power semiconductor elements embedded in the printed circuit board, one of which serves as a high-side switch and one as a low-side switch.

EP 2 588 340 B1 shows a method for operating a drive unit in a motor vehicle with at least a three-phase electric machine. The three-phase electric machine can be controlled via an inverter, wherein the inverter comprises switching elements in the form of half-bridges and each half-bridge is electrically connected to one phase of the electric machine.

An object of the present disclosure is to provide a solution by which a versatile half-bridge circuit can be provided for a voltage supply device.

This object is achieved by the subject matter of disclosed herein.

A first aspect of the present disclosure relates to a voltage supply device for a motor vehicle. The voltage supply device may be comprised in a motor vehicle. In an alternative example, the voltage supply device may be comprised in another device not related to a motor vehicle or may be understood as a separate device that is not comprised in any other device.

The voltage supply device is designed to supply voltage, in particular in the motor vehicle. Supplying the voltage includes, for example, making the voltage available for operating at least one consumer, i.e., for example, another device or apparatus. In a preferred example, the at least one consumer is a drive device of the motor vehicle, in particular an electric motor of the motor vehicle. In the following, it is assumed that the voltage supply device can be coupled or is coupled to an energy supply and can be supplied or is supplied with electrical energy by this energy supply. The energy supply may be, for example, a high-voltage battery or another battery of the motor vehicle. For coupling to the energy supply, the voltage supply device has connections to a negative pole and to a positive pole of an energy supply. Furthermore, it is assumed in the following that the voltage supply device has an output or voltage output, which may comprise, for example, an output connection at which the supplied voltage can be tapped or is tapped. Coupled within the meaning of the present disclosure comprises electrical connection and/or attachment.

The voltage supply device may, for example, be designed as an inverter or rectifier. In a particularly preferred example, it is an inverter which is arranged between the high-voltage battery of the motor vehicle, which provides a DC voltage, and the drive device, which requires an AC voltage, and is designed to convert the DC voltage provided by the high-voltage battery into the voltage required by the drive device. Alternatively or in addition, the voltage supply device may be a DC voltage converter, an inverter, and/or a charging device, in particular a part of the charging device. In a preferred example, the voltage supply device thus represents a component of the motor vehicle that supplies a desired voltage to at least one other component of the motor vehicle.

The voltage supply device has at least one carrier plate on which a half-bridge circuit is arranged. The half-bridge circuit comprises two switches that can be switched on alternately. The two switches are referred to as high-side switches and low-side switches. The half-bridge circuit therefore comprises the high-side switch and the low-side switch. The high-side switch and the low-side switch each comprise at least one switchable semiconductor chip. In a preferred example, the high-side switch and the low-side switch each comprise a plurality of individual semiconductor chips. Furthermore, in another preferred example, they each comprise the same number of switchable semiconductor chips. The individual switchable semiconductor chips can be positioned on the carrier plate, for example, using a sintering process. The carrier plate can be understood, for example, as a printed circuit board on which at least the respective at least one semiconductor chip of the high-side switch and the low-side switch is arranged.

The at least one semiconductor chip can, for example, be designed as a silicon carbide (SiC) chip and/or as an insulated-gate bipolar transistor (IGBT). Alternatively or in addition, the at least one semiconductor chip can be based on another switchable semiconductor, such as gallium nitride (GaN). The terms "semiconductor chip" and "switchable semiconductor chip" are to be understood as synonymous in the context of the present disclosure.

The present disclosure is based at least on the realization that the high-side switch and the low-side switch can each be implemented with one or more semiconductor chips, wherein the number of semiconductor chips used may depend on the current required by at least one consumer for which the voltage supply device supplies the voltage. This means that, if necessary, numerous different semiconductor chip arrangements may be developed in order to enable this adaptation to a total of a plurality of different consumers. However, this can lead to complex and cost-intensive development and/or manufacturing processes. In order to provide a versatile half-bridge circuit for a voltage supply device, it should therefore be possible to adjust the number of semiconductor chips per switch of the half-bridge circuit with little effort. According to the present disclosure, this is achieved by providing a plurality of chip positions on the carrier plate, which can then be occupied either completely or only partially with semiconductor chips.

A plurality of chip positions are arranged on the carrier plate for the high-side switch and the low-side switch, each of which chip positions can be occupied by exactly one semiconductor chip. A chip position is a fixed, i.e., defined, location and/or area on the carrier plate where the semiconductor chip can or cannot be attached or positioned. At least two chip positions are provided for each switch. In a preferred example, up to six chip positions are provided per switch. More than six chip positions are possible in an alternative example. A chip position that is occupied by exactly one semiconductor chip is a chip position at which exactly one semiconductor chip is installed, which is thus part of the high-side switch or the low-side switch. An unoccupied chip position is an empty location or area on the carrier plate where no semiconductor chip is or will be placed, so that the high-side switch or low-side switch does not have a semiconductor chip there.

The number of occupied chip positions depends on a specified current strength for an output current of the voltage supply device. In other words, the carrier plate for the high-side switch and the low-side switch each has a plurality of specified areas where exactly one semiconductor chip can be arranged, but does not have to be arranged, for the voltage supply device to be functional. The number of semiconductor chips actually placed on the carrier plate is variable and determines the current strength that can be achieved or is achieved for the output current. For example, if a current of approximately 100 amps can be achieved per semiconductor chip, three chip positions of the high-side switch and three chip positions of the low-side switch can be occupied by one semiconductor chip each in order to achieve a current between 300 amps and 350 amps. For a higher current, more chip positions can be occupied and/or for lower currents, fewer chip positions can be occupied. Other relationships between the current level and the number of semiconductor chips than in the example described are possible.

One advantage of the voltage supply device is that, with exactly one design of the carrier plate comprising consistent chip positions, a plurality of different currents can be achieved, so that the voltage supply device can be flexibly and easily adapted to the current requirement of a consumer from a group of a plurality of consumers with individual current requirements. At least the carrier plate with the chip positions can therefore be universally applicable regardless of the current requirement of the consumer, as this is only relevant when the chip positions are occupied by the semiconductor chips. The adaptability to the current requirement of the consumer thus provides a versatile half-bridge circuit for a voltage supply device.

If the voltage supply device is the inverter and is used to supply an alternating voltage to the drive device of the motor vehicle, the voltage supply device may comprise three carrier plates, each carrier plate being assigned to one phase, so that three-phase alternating current can be or is supplied by the voltage supply device.

One embodiment provides for at least two rows of a plurality of adjacent chip positions to be arranged on the carrier plate for the high-side switch and the low-side switch. The chip positions are not all positioned in exactly one row, but are divided into at least two rows. In a preferred example, the chip positions are arranged in exactly two rows on the carrier plate. Between the respective at least two rows, there is a respective terminal row in which a drain terminal, a gate terminal, and a source-connection of the half-bridge circuit are arranged. In the preferred example with exactly two rows, a first row of the two rows is located, for example, on a first side relative to the terminal row, and a second row of the two rows is located on a second side different from the first side relative to the terminal row. The first side and the second side may face each other. The high-side switch and the low-side switch are designed analogously to each other. The arrangement in rows results in a compact arrangement of a plurality of chip positions around the terminals arranged in the terminal row, i.e., around the drain terminal, the gate terminal, and the source terminal, so that fluctuations between distances of individual chip positions to the respective terminal can be kept small and the distances themselves can also be kept small. This results in a sensible and suitable arrangement of the chip positions overall.

The respective drain terminal, gate terminal, and source terminal can alternatively be referred to or understood as the respective drain switch, gate switch, or source switch, or as the respective drain electrode, gate electrode, or source electrode of the half-bridge circuit. Drain, gate, and source refer here to typical components of a half-bridge circuit. Alternatively, the respective drain terminal, gate terminal, and source terminal can be referred to as the working electrode, control electrode, and reference electrode, respectively.

Another embodiment comprises, for each of the high-side switch and the low-side switch, the at least one semiconductor chip having a drain terminal that is electrically coupled to the drain terminal of the respective terminal row, a gate terminal that is electrically coupled to the gate terminal of the respective terminal row, and a source terminal that is electrically coupled to the source terminal of the respective terminal row. At least the respective gate terminals and/or the respective source terminals are electrically coupled to each other via a respective connecting element. For the respective semiconductor chip, for example, the source terminal is connected via the connecting element to the source terminal of the high-side switch or the low-side switch. This can be provided analogously for the gate terminal. In another example, the drain terminal for the respective semiconductor chip may additionally or alternatively be connected to the drain terminal of the high-side switch or the low-side switch via a connecting element. The connecting element may be designed as a cable, in particular as a wire.

If, for example, six different chip positions are arranged in the two rows around the terminal row of the high-side switch or the low-side switch, a total of up to six different connecting elements may be provided between the individual source terminals or gate terminals per high-side switch or low-side switch, if the high-side switch and the low-side switch each comprise six individual semiconductor chips. Depending on the number of semiconductor chips, different numbers of drain terminals, gate terminals, and source terminals of semiconductor chips are coupled to the terminal row of the high-side switch or the low-side switch and the terminals located there. This provides a cost-effective way of electrically connecting the respective semiconductor chip.

A preferred embodiment provides that, if not all chip positions are occupied, the semiconductor chips are positioned such that they are arranged symmetrically around the respective terminal row and/or that the distance between the semiconductor chips is maximum and/or that the respective distances between each pair of semiconductor chips deviate from each other only within a specified tolerance range. The specified tolerance range can, for example, be between 0 percent on the one hand and 5 percent, 10 percent, 15 percent, 20 percent, or, in particular, 30 percent relative to the respective distance on the other hand. Other tolerance ranges, in particular those defined by any values between the values mentioned, are possible. Symmetrical means an arrangement relative to an axis of symmetry, wherein, for example, a first axis of symmetry may run centrally through the terminal row parallel to a longitudinal direction of the terminal row and a second axis of symmetry may run through a respective central chip position and/or a respective center point of the respective rows perpendicular to a longitudinal direction of the respective row. The first and second axes of symmetry are in particular perpendicular to each other. Other axes of symmetry are possible, which, for example, connect a first chip position of the first row with a last chip position of the second row or vice versa, or are arranged in a different manner. Symmetrical can alternatively or additionally comprise point symmetry with respect to a given reference point. The maximum distance refers to possible distances between two semiconductor chips of a switch, respectively, and/or taking into account the semiconductor chips of both switches in relation to each other.

For example, if six chip positions are provided in the two rows, and thus three chip positions per row per switch, but only four of the six chip positions are occupied by semiconductor chips, then, for example, in each of the two rows, a middle chip position between two end chip positions of the row is left free, so that the two semiconductor chips per row are as far apart as possible and the distances between each pair of the four semiconductor chips are similar to each other and thus only deviate from each other within the specified tolerance range or may even be the same. This arrangement is also symmetrical, for example, with respect to the first axis of symmetry and the second axis of symmetry. However, if, for example, only three chip positions per switch are occupied by semiconductors, the first and third chip positions in the respective first row, and thus the two end chip positions, may be occupied, but in the respective second row only a second chip position, and thus the middle chip position between the two end chip positions, may be occupied. This also results in a symmetrical arrangement with respect to, for example, the second axis of symmetry, as well as distances that are within the specified tolerance range.

These specifications for the distances between the semiconductor chips and the symmetrical arrangement can at least support active cooling of the voltage supply device, as they favor spaces between individual semiconductor chips, thereby optimizing heat dissipation between the semiconductor chips with regard to connected cooling. The additional space for heat dissipation created by the distances between the semiconductor chips can, for example, lead to a lower load on the connected cooler, which in turn can reduce the cost of the cooler. Furthermore, relatively similar distances between the individual semiconductor chips and the gate terminal, drain terminal, and source terminal of the respective connection series can be made possible, whereby, for example, delays between individual signals within the voltage supply device due to different transmission path lengths can at least be reduced. Semiconductor chips connected in parallel, i.e., the semiconductor chips per switch, require synchronous switching times, as otherwise, for example, an imbalance in the load on the semiconductor chips and/or semiconductor chip stress may occur. The described arrangements of the semiconductor chips match the effective gate-source loop lengths to each other, thus achieving synchronous switching times at least to a large extent.

Another embodiment provides that the voltage supply device has an upper plate. The upper plate is attached with at least part of an upper plate edge area to at least part of a carrier plate edge area. The upper plate edge area is a part of the upper plate that is arranged at an edge of the upper plate and thus forms an edge area of the upper plate. The upper plate edge area protrudes, for example, from an upper plate center area of the upper plate when viewed in a vertical direction of the upper plate, for example by being stepped from it. The carrier plate edge area is a part of the carrier plate that is arranged at an edge of the carrier plate and thus forms an edge area of the carrier plate. The carrier plate can be referred to as a bottom plate for the upper plate, or the upper plate can be referred to as a cover plate for the carrier plate.

A volume space is formed between the upper plate center area, i.e., a center area of the upper plate located between, for example, two opposite upper plate edge areas, and an opposite carrier plate center area, i.e., a center area of the carrier plate located between two opposite carrier plate edge areas. The volume space is a closed cavity, at least in the direction of the part of the edge areas where the upper plate is attached to the carrier plate. In the area of the carrier plate center area and the upper plate center area, the carrier plate and the upper plate are thus arranged at a distance from each other. They do not lie directly on top of each other there. At least in the part of the upper plate edge area and the carrier plate edge area where the upper plate and the carrier plate are fastened to each other, in a preferred example there is no distance greater than 0 between the carrier plate and the upper plate, so that they lie directly or indirectly on top of each other there via an intermediate layer. An electrical coupling between the carrier plate and the upper plate is therefore achieved at least in part of the carrier plate edge area and at least part of the upper plate edge area.

In the volume space, i.e., in the area between the center area of the carrier plate and the center area of the upper plate, at least one first coupling element protruding from the upper plate toward the carrier plate is arranged for the low-side switch. The at least one first coupling element forms an electrical connection between the upper plate and the carrier plate. The upper plate is electrically coupled to at least one connection of the at least one semiconductor chip of the low-side switch via the at least one first coupling element. In other words, the upper plate can form or provide an electrical coupling to one of the connections of the respective semiconductor chip of the low-side switch. No additional component, such as a connecting element, is required for this, as the upper plate serves as a kind of connecting element.

The upper plate and the carrier plate together form a relatively compact structure, wherein a total height can be specified in the vertical direction of the voltage supply device. If the total height is kept small, in particular minimized, a low inductance of the voltage supply device can be achieved. The upper plate also covers the carrier plate, thereby spatially separating and protecting the carrier plate with the semiconductor chips arranged thereon from the environment of the voltage supply device.

In one example, the volume space between the upper plate and the carrier plate can be filled with a filling material, in particular with epoxy resin. This results, for example, in high-voltage insulation within the voltage supply device and protection against mechanical damage and/or contamination by particles and/or moisture.

A further embodiment comprises that a number of first coupling elements and/or their arrangement on the upper plate is predetermined depending on the number of occupied chip positions and/or their arrangement on the carrier plate for the low-side switch. The respective first coupling element is attached to the upper plate in such a way that it at least partially faces the at least one connection of the respective semiconductor chip with which it is electrically coupled. This means that, depending on the specified current and thus on the number of semiconductor chips per high-side switch and low-side switch, an individual upper plate can be provided, the arrangement of first coupling elements on which depends on the number and arrangement of the semiconductor chips on the carrier plate and thus on the occupied chip positions. Although the carrier plate can be flexibly adapted to the consumer within the scope of the positioning of the semiconductor chips, the upper plate and thus part of the voltage supply device is fixed for exactly one number and arrangement of semiconductor chips and is therefore not flexible. However, the described number and arrangement of the first coupling elements eliminates the need for additional connecting elements to be manufactured, thereby reducing the overall manufacturing time and increasing the robustness of the voltage supply device.

Furthermore, an embodiment provides that the source terminal of the at least one semiconductor chip of the low-side switch is electrically coupled to the upper plate via the at least one first coupling element. This results in this source terminal being electrically coupled via the first coupling element to at least part of the upper plate edge area, via at least part of the upper plate edge area to at least part of the carrier plate edge area to which at least part of the upper plate edge area is attached, and, via the at least one part of the carrier plate edge area, to the negative pole of the power supply of the voltage supply device. The upper plate thus couples the source terminal of the respective semiconductor chip of the low-side switch to the negative pole of the power supply.

Alternatively or additionally, the drain terminal of the respective semiconductor chip of the high-side switch can be electrically coupled to the positive pole of the power supply of the voltage supply device via a first sub-area of the carrier plate center area. For this purpose, the carrier plate center area is electrically isolated or decoupled from the carrier plate edge area. These two connections to the positive and negative poles are typical for half-bridge circuits, because in these circuits the positive pole is usually connected to the drain terminal of the high-side switch, i.e., the high-side drain, whereas the negative pole is usually connected to the source terminal of the low-side switch, i.e., the low-side source. This leads to a sensible design of the voltage supply device, wherein the at least one coupling element, the upper plate, and at least the first sub-area of the carrier plate center area are used to transfer energy.

In a preferred example, the first sub-area is a part of the carrier plate center area located in an area of the carrier plate associated with the high-side switch. Viewed in a transverse direction of the carrier plate, the first sub-area is arranged centrally between two opposing carrier plate edge areas, wherein the positive pole can be arranged centrally between two negative poles or adjacent to exactly one negative pole, viewed in the transverse direction. In this example, the high-side switch and the low-side switch can be arranged next to each other when viewed in a longitudinal direction of the carrier plate. Ultimately, the carrier plate edge and the carrier plate center area are each used to transmit energy and are understood to be electrically conductive areas of the carrier plate that are electrically decoupled from each other. The upper plate is also electrically conductive.

Another embodiment provides for at least a second coupling element to be arranged in the volume space. The second coupling element electrically couples the source terminal of the at least one semiconductor chip of the high-side switch to a second sub-area of the carrier plate center area. The second sub-area is electrically coupled to the drain terminal of the at least one semiconductor chip of the low-side switch on the one hand and to an output of the voltage supply device at which the output current can be supplied on the other hand. In a preferred example, exactly one second coupling element is provided per row of the high-side switch, which electrically couples the source terminals of the semiconductor chips of this row to each other and to the second sub-area of the carrier plate center area. The first sub-area and the second sub-area of the carrier plate center area are electrically decoupled from each other, i.e., they are electrically isolated from each other. They are spatially separated from each other. In a preferred example, the second sub-area is a part of the carrier plate center area that is located in an area of the carrier plate that is associated with the low-side switch. For the electrical coupling of the at least one second coupling element to the second sub-area, at least one coupling area may be provided in the second sub-area at which no chip position is arranged.

The second coupling element can be used to establish an electrical connection between the source terminals of the high-side switch, i.e., the high-side source, and the drain terminals, i.e., the low-side drain, which is required to operate the half-bridge circuit. In a half-bridge circuit, the output voltage is also tapped between these two terminals, which is why the electrical coupling to the output of the voltage supply device is also established via the second sub-area. This part of the voltage supply device is provided simply and in a space-saving manner with the aid of the second coupling element and the second sub-area.

In a further embodiment, the voltage supply device is provided with at least one thermistor device, which comprises a thermistor and is designed to detect a temperature of or in the voltage supply device, so that temperature monitoring of the voltage supply device can be provided. For example, depending on a detected temperature, active cooling, in particular air cooling, for the voltage supply device can be activated or deactivated.

In a preferred example, the voltage supply device described is positioned in a housing. In the case of an inverter for a three-phase voltage signal, for example, three voltage supply devices, each of which has a housing, are electrically coupled to one another, or three carrier plates with their respective upper plates are electrically coupled to one another and arranged in a common housing, wherein these three carrier plates with their respective upper plates can be understood as precisely one voltage supply device.

Another aspect of the present disclosure relates to a motor vehicle with the voltage supply device described above. In the motor vehicle, this is coupled, for example, via the positive pole and the negative pole, directly or indirectly via at least one intermediate component, to the energy supply, such as the high-voltage battery. The output can be coupled directly or indirectly via at least one intermediate component to an AC voltage consumer, in particular the drive system of the motor vehicle. Other uses or arrangements of the voltage supply device in the motor vehicle are possible. The motor vehicle is, for example, a passenger car, a truck, a bus, and/or a motorcycle. In one example, the motor vehicle can be an electric vehicle and/or a hybrid vehicle.

Another aspect of the present disclosure relates to a manufacturing method for the voltage supply device described above. The manufacturing method comprises, for example, mounting the at least one switchable semiconductor chip for the high-side switch and the low-side switch on the carrier plate. The mounting can be carried out using a sintering process. In addition, the manufacturing method may comprise attaching, in particular soldering, drain terminals, gate terminals, and source terminals of the terminal rows, the at least one second coupling element, and/or connections at the negative pole, the positive pole, and/or the output on the carrier plate. In addition, the thermistor and thermistor connections for power supply and signal transmission of the thermistor can be attached to the carrier plate as part of the fastening process. The manufacturing method may comprise fastening, in particular soldering, the connecting elements between the gate terminal of the respective semiconductor chip and the gate terminal of the respective terminal row and/or between the source terminal of the respective semiconductor chip and the source terminal of the respective terminal row on the carrier plate equipped with the connections and the semiconductor chips.

The manufacturing method may then comprise attaching, in particular soldering, the upper plate to the carrier plate to produce a carrier plate-upper plate component. The manufacturing method may comprise arranging, in particular overmolding and/or injection molding, a housing around the carrier plate-upper plate component. The housing typically has connections passing through a housing wall, at least for the connections of the two rows of connections, i.e., their drain terminals, gate terminals, and source terminals, and, if applicable, the thermistor connections.

This makes it clear how, for example, depending on the current strength of the desired output current, flexible adaptation is possible by varying the first described method step, i.e., the assembly of the carrier plate with the switchable semiconductor chips, without varying the carrier plate. This is particularly advantageous for variable current strengths due to different consumers in the motor vehicle.

The voltage supply device and/or the motor vehicle may have a control device with at least one processor for controlling the voltage supply device, in particular the half-bridge circuit.

Further features of the present disclosure can be found in the figures and the description of the figures. The features and combinations of features mentioned above in the description, as well as the features and combinations of features mentioned below in the description of the figures and/or shown in the figures alone, are usable not only in the combination specified in each case, but also in other combinations or on their own.

The present disclosure will now be explained in more detail on the basis of a preferred embodiment and with reference to the drawings.

Other objects, advantages and novel features of the present disclosure will become apparent from the following detailed description of one or more preferred embodiments when considered in conjunction with the accompanying drawings.

### BRIEF DESCRIPTION OF THE DRAWINGS

FIG. 1 shows a schematic representation of a motor vehicle with a voltage supply device,

FIG. 2 shows a top view of three different carrier plates for different currents of an output current,

FIG. 3 shows an exploded view of a carrier plate with four different possible upper plates,

FIG. 4 shows a schematic representation of a half-bridge circuit, and

FIG. 5 shows a schematic representation of method steps in a manufacturing method for a voltage supply device.

### DETAILED DESCRIPTION OF THE DRAWINGS

In the figures, elements with the same function are assigned the same reference signs.

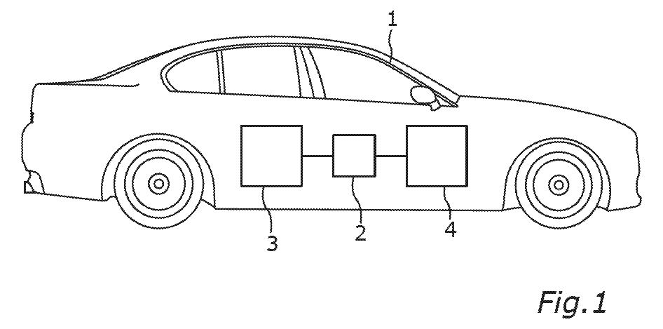

FIG. 1 shows a motor vehicle 1 that has a voltage supply device 2. In the example shown, the voltage supply device 2 is an inverter that is arranged between a high-voltage battery 3 of the motor vehicle 1 and a drive device 4 of the motor vehicle 1. The drive device 4 is, for example, an electric motor. The voltage supply device 2 can, for example, convert a direct voltage supplied by the high-voltage battery 3 into an alternating voltage, in particular a three-phase alternating voltage, for the drive device 4. Alternatively or in addition to the design as an inverter, the voltage supply device 2 can, for example, be designed as a rectifier, a DC voltage converter, a converter, and/or a charging device for the motor vehicle 1, in particular as a high-voltage charging device.

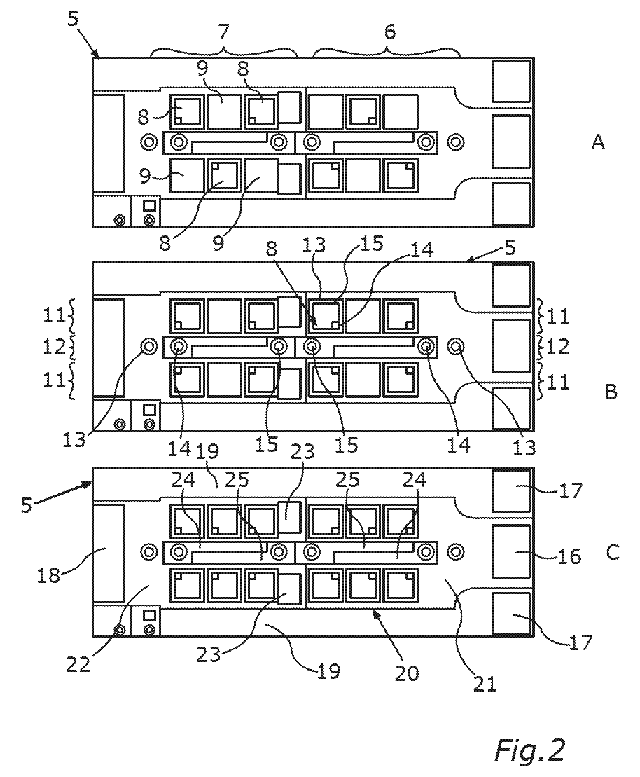

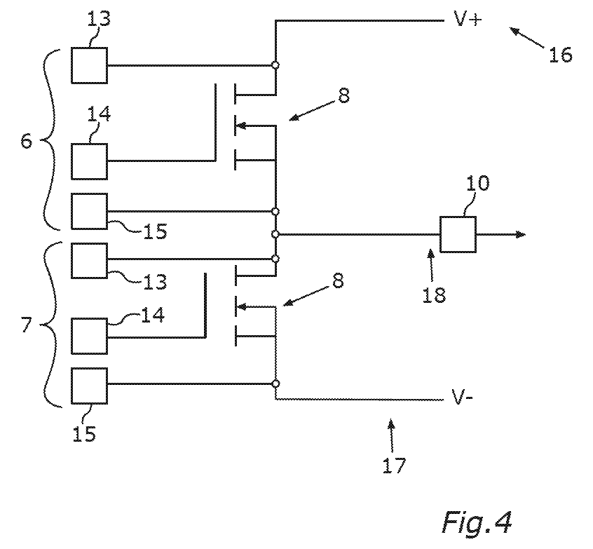

FIG. 2 shows three different designs A, B, and C of a carrier plate 5 of the voltage supply device 2 as examples. The carrier plate 5 comprises a half-bridge circuit comprising two switches 6, 7, which are referred to as a high-side switch 6 and a low-side switch 7. The high-side switch 6 and the low-side switch 7 each comprise at least one switchable semiconductor chip 8. However, for the high-side switch 6 and the low-side switch 7, the carrier plate 5 has a plurality of chip positions 9, each of which can be occupied by exactly one semiconductor chip 8. The number of occupied chip positions 9 depends on the specified current strength of an output current 10 (see reference sign 10 in FIG. 4) of the voltage supply device 2.

In design A, for example, of the total of six chip positions 9 of the high-side switch 6 and the low-side switch 7, three chip positions 9 are occupied by one semiconductor chip 8 each, wherein the remaining three chip positions 9 remain unoccupied. In configuration B, four semiconductor chips 8 occupy respective chip positions 9 of the high-side switch 6 and the low-side switch 7, so that only two of the chip positions 9 per switch 6, 7 are unoccupied. In configuration C, all chip positions 9 are occupied, so that six semiconductor chips 8 from the high-side switch 6 and six semiconductor chips 8 from the low-side switch 7 are included. Other numbers and/or arrangements than the numbers and/or arrangements of chip position 9 and/or semiconductor chips 8 shown here are possible.

For configuration B, it is shown here as an example that two rows 11 of a plurality of adjacent chip positions 9 can be provided on the carrier plate 5 for the high-side switch 6 and the low-side switch 7. A respective terminal row 12 may be arranged between the respective two rows 11, in each of which a drain terminal 13, a gate terminal 14, and a source terminal 15 of the half-bridge circuit are arranged. These individual connections 13, 14, 15 are each enclosed by both the high-side switch 6 and the low-side switch 7.

For the high-side switch 6 and low-side switch 7, the respective at least one semiconductor chip 8 has a drain terminal 13 that is electrically coupled to the drain terminal 13 of the respective terminal row 12. Similarly, the respective at least one semiconductor chip 8 has a gate terminal 14 that is electrically coupled to the gate terminal 14 of the respective terminal row 12. Furthermore, the respective at least one semiconductor chip 8 has a source terminal 15, which is electrically coupled to the source terminal 15 of the respective terminal row 12. These connections 13, 14, 15 are shown here as examples for one of the semiconductor chips 8 in design B.

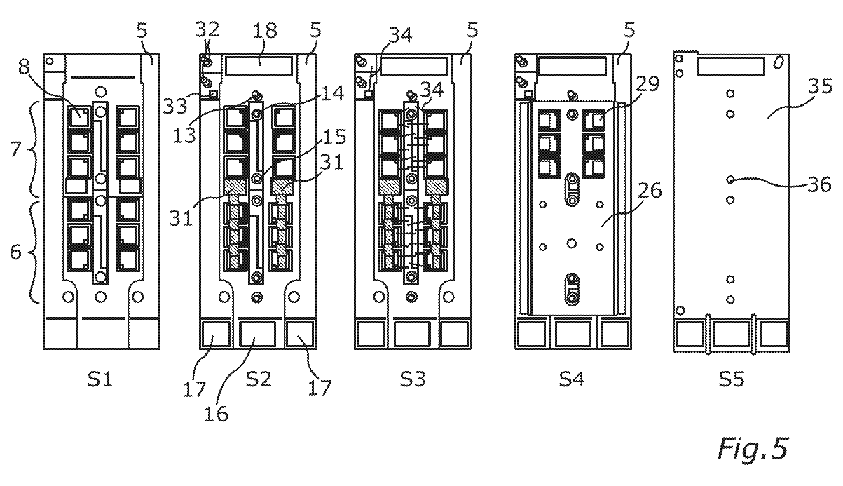

At least the couplings described between the source terminals 15 and/or the gate terminals 14 can be realized in each case by a connecting element 34 (see reference sign 34 in FIG. 5). In this case, the respective gate terminals 14 or source terminals 15 of the respective semiconductor chip 8 can each be electrically coupled to a respective gate terminal area 24 or source terminal area 25 of the respective terminal row 12, in particular via the respective connecting element 34. The connecting elements 34 are, for example, cable connections, in particular wire connections.

For design C, a positive pole 16 and two negative poles 17 of a power supply for the voltage supply device 2 are also outlined, as well as an output 18 at which, for example, the output current with the specified current strength can be tapped.

The carrier plate 5 may have a carrier plate center area 20, which may comprise a first sub-area 21 and a second sub-area 22. Adjacent to the carrier plate center area 20, the carrier plate 5 may have at least one carrier plate edge area 19, in particular two opposite carrier plate edge areas 19.

If not all chip positions 9 are occupied, the semiconductor chips 8 may be positioned relative to one another in such a way that they are arranged symmetrically, for example with respect to an axis of symmetry, such as the terminal row 12, and/or a reference point. Alternatively or in addition, the semiconductor chips 8 can be positioned relative to each other in such a way that the distance between individual semiconductor chips 8 is maximum and/or that the respective distances between two semiconductor chips 8 only deviate from each other within a specified tolerance range.

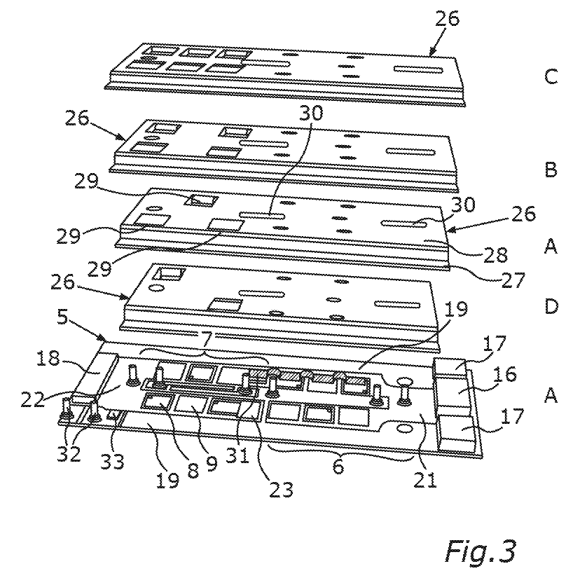

FIG. 3 shows an exploded view of the carrier plate 5 according to design A with four designs A, B, C, and D of an upper plate 26 of the voltage supply device 2. Designs A, B, and C of the carrier plate 5 from FIG. 2 and the upper plates 26 outlined here fit together, i.e., they correspond to each other. Furthermore, design D shows an upper plate 26 for a carrier plate 5 that comprises only two semiconductor chips 8 for the high-side switch 6 and the low-side switch 7 and is not shown in FIG. 2.

The upper plate 26 is attached to at least part of the carrier plate edge area 19 of the carrier plate 5 with at least part of an upper plate edge area 27 of the upper plate 26, which can protrude, in particular in a stepped manner, from an upper plate center area 28 when viewed in the upward direction of the upper plate 26. In an assembled state, this fastening is selected such that the at least part of the upper plate edge area 27 and the at least part of the carrier plate edge area 19 lie directly on top of each other and are, for example, soldered to each other. Electrical energy can thus be transmitted via the at least part of the upper plate edge area 27 to the at least part of the carrier plate edge area 19 and vice versa.

Between the upper plate center area 28 and the opposite carrier plate center area 20, a volume space is formed in the assembled state, i.e., the carrier plate 5 and the upper plate 26 are spaced apart from each other there. At least one first coupling element 29 protruding from the upper plate 26 toward the carrier plate 5 is arranged in the volume space for the low-side switch 7. The upper plate 26 is electrically coupled via the at least one first coupling element 29 to at least one connection 13, 14, 15 of the at least one semiconductor chip 8 of the low-side switch 7. The number of first coupling elements 29 and their arrangement on the upper plate 26 may depend on the number of occupied chip positions 9 and their arrangement on the carrier plate 5 for the low-side switch 7. The respective first coupling element 29 is, for example, attached to the upper plate 26 in such a way that it at least partially faces the at least one connection 13, 14, 15 of the respective semiconductor chip 8 to which it is electrically coupled.

Depending on the specified current strength and thus depending on the arrangement and number of semiconductor chips 8, different upper plates 26 are therefore formed, as is illustrated here in an exemplary manner for designs A to D. It is also clear that the respective upper plate 26 can have a plurality of connection recesses 30, for example for the drain terminals 13, gate terminals 14, and/or source terminals 15 of the terminal rows 12.

In a preferred example, the source terminal 15 of the at least one semiconductor chip 8 of the low-side switch 7 is electrically coupled via the at least one first coupling element 29 and the at least part of the upper plate edge area 27 to the at least part of the carrier plate edge area 19 to which the at least part of the upper plate edge area 27 is attached, and via the at least part of the carrier plate edge area 19 with the negative pole 17 of the power supply of the voltage supply device 2. Furthermore, the drain terminal 13 of the respective semiconductor chip 8 of the high-side switch 6 can be electrically coupled via the first sub-area 21 of the carrier plate center area 20 to the positive pole 16 of the power supply of the voltage supply device 2.

Furthermore, at least one second coupling element 31 may be arranged in the volume space and can be understood, for example, as a clamp between the upper plate 26 and the carrier plate 5. The second coupling element 22 connects the source terminal 15 of the at least one semiconductor chip 8 of the high-side switch 6 to the second sub-area 22 of the carrier plate center area 20 and electrically couples them to each other. The second sub-area 22 can be electrically coupled to the drain terminal 13 of the at least one semiconductor chip 8 of the low-side switch 7 on the one hand and to the output 18 of the voltage supply device 2, at which the output current 10 is supplied, on the other hand. In a preferred example, two second coupling elements 31 are provided, and thus one second coupling element 31 per row 11 of the high-side switch 6. Here, it also becomes clear that a coupling area 23 for the respective second coupling element 31 can be provided in the area of the second subarea 22, wherein the second coupling element 31 can be coupled to the second subarea 22 at the coupling area.

In one example, the voltage supply device 2 may have at least one thermistor 33 that is designed to detect a temperature of the voltage supply device 2, so that temperature monitoring of the voltage supply device 2 can be provided. Two thermistor connections 32 for the thermistor 33 are also shown here.

FIG. 4 illustrates the half-bridge circuit. The individual drain terminals 13, gate terminals 14, and source terminals 15 for the high-side switch 6 and the low-side switch 7 are shown here. FIG. 4 illustrates why the individual components of the voltage supply device 2, as described above, are electrically coupled to each other.

FIG. 5 shows five possible method steps S1 to S5 of a manufacturing method for the voltage supply device 2. A method step S1 comprises, for example, equipping the carrier plate 5 with at least one switchable semiconductor chip 8 for the high-side switch 6 and the low-side switch 7. Here, design C is outlined as an example, in which six semiconductor chips 8 are provided for the high-side switch 6 and six semiconductor chips 8 are provided for the low-side switch 7. The coupling areas 23, the gate terminal areas 24, the source terminal areas 25, and the sub-areas 21, 23 of the carrier plate 5 are already visible, i.e., created, on the carrier plate 5.

In a method step S2, for example, the drain terminals 13, gate terminals 14, and source terminals 15 of the respective terminal row 12, of the second coupling elements 31 and/or of connections at the negative pole 17, the positive pole 16, and the output 18, which are each shown here, are fastened, in particular soldered. In method step S2, the thermistor connections 32 and the thermistor 33 can also be fastened to the carrier plate 5. In a method step S3, the connecting elements 34 can be fastened, in particular soldered or attached in some other way, at least between the gate terminal 14 of the respective semiconductor chip 8 and the gate terminal 14 of the respective terminal row 12, and analogously for the source terminals 15. This is illustrated here by connecting parts between the gate terminals 14 of the respective semiconductor chip 8 and the respective gate terminal area 24 or the source terminals 15 of the respective semiconductor chip 8 and the respective source terminal area 25. The connecting elements 34 are selected such that they are substantially the same length, wherein a predetermined tolerance range can be taken into account in essence.

In a method step S4, the upper plate 26 can be fastened, in particular soldered, to the carrier plate 5 to produce a carrier plate-upper plate component. Here it becomes clear that the respective first coupling elements 29 in the area of the low-side switch 7 are each coupled to the source terminals 15 of the semiconductor chips 8 of the low-side switch 7.

In a method step S5, a housing 35 can be arranged, in particular overmolded and/or injection molded, around the carrier plate-upper plate component. After this method step, the voltage supply device 2 is complete. The housing 35 may have a plurality of connection recesses 36 so that a plurality of housings 35 can be electrically coupled to one another.

Overall, the examples show a two-level operation of a voltage supply device 2, such as an inverter for a motor vehicle 1. A scalable design is shown that allows the placement of two to six semiconductor chips 8 per switch 6, 7 for scalable current. The chip positions 9 specify a chip pattern that allows the placement of semiconductor chips 8 ranging from 4 mm x 4 mm to 6 mm x 6 mm. Furthermore, an agnostic chip design is enabled, allowing for delivery by multiple suppliers. Internal clip-type busbar structures that enable high-current transmission and provide a heat path for cooler operation of active devices are feasible. In addition, a high-voltage connection via block structures for thermal decoupling of external energy from active elements within the module and/or a high-voltage connection that enables a single connection step (no stacked connection system) is possible. A molded assembly for high strength and for sintering/soldering the assembly to the inverter assembly under high pressure can be manufactured, wherein control connections can be implemented via external press-fit pins (here, connecting elements 34). The manufacturing or assembly process with a minimum of four and a maximum of five assembly steps comprises: 1. Sintering (S1) 2. Soldering (S2, optional) 3. Wire bonding (S3) 4. Soldering (S4) and 5. Overmolding (S5).

The foregoing disclosure has been set forth merely to illustrate the present disclosure and is not intended to be limiting. Since modifications of the disclosed embodiments incorporating the spirit and substance of the present disclosure may occur to persons skilled in the art, the present disclosure should be construed to include everything within the scope of the appended claims and equivalents thereof.

### LIST OF REFERENCE SIGNS

1 motor vehicle

2 voltage supply device

3 high-voltage battery

4 drive device

5 carrier plate

6 high-side switch

7 low-side switch

8 semiconductor chip

9 chip position

10 output current

11 rows

12 terminal row

13 drain terminal

14 gate terminal

15 source terminal

16 positive pole

17 negative pole

18 output

19 carrier plate edge area

20 carrier plate center area

21 first sub-area

22 second sub-area

23 coupling area

24 gate connection area

25 source connection area

26 upper plate

27 upper plate edge area

28 upper plate center area

29 first coupling element

30 connection recesses

31 second coupling elements

32 thermistor connection

33 thermistor

34 connecting element

35 housing

36 connection recess

What is claimed is:

1. A voltage supply device for a motor vehicle comprising:
at least one carrier plate on which a half-bridge circuit is arranged, wherein the half-bridge circuit comprises a high-side switch and a low-side switch, each of which comprises at least one switchable semiconductor chip,
wherein a plurality of chip positions are arranged on the carrier plate for the high-side switch and the low-side switch, each of which chip positions can be occupied by exactly one semiconductor chip, wherein a number of occupied chip positions depends on a predetermined current strength for an output current of the voltage supply device.

2. The voltage supply device according to claim 1,
wherein, in each case, at least two rows of a plurality of respective adjacent chip positions are arranged on the carrier plate for the high-side switch and the low-side switch, with a respective terminal row being arranged between the respective at least two rows, in which a drain terminal, a gate terminal, and a source terminal of the half-bridge circuit are arranged in each case.

3. The voltage supply device according to claim 2,
wherein, for each of the high-side switch and the low-side switch, the at least one semiconductor chip has a drain terminal that is electrically coupled to the drain terminal of the respective terminal row, a gate terminal that is electrically coupled to the gate terminal of the respective terminal row, and a source terminal that is electrically coupled to the source terminal of the respective terminal row,
wherein at least the respective gate terminals and/or the respective source terminals are electrically coupled to each other via a respective connecting element.

4. The voltage supply device according to claim 2,
wherein not all chip positions are occupied, and wherein the semiconductor chips are positioned such that they are arranged symmetrically around the respective terminal row and/or a distance between the semiconductor chips is maximum and/or the respective distances between each pair of semiconductor chips deviate from each other only within a predetermined tolerance range.

5. The voltage supply device according to claim 1, comprising:
an upper plate that is attached to at least a portion of a carrier plate edge area with at least one part of an upper plate edge area protruding from an upper plate center area in a vertical direction of the upper plate,
wherein a volume space is formed between the upper plate center area and an opposite carrier plate center area, in which at least one first coupling element protruding from the upper plate in a direction of the carrier plate is arranged for the low-side switch, via which the upper plate is electrically coupled to at least one terminal of the at least one semiconductor chip of the low-side switch.

6. The voltage supply device according to claim 5,
wherein a number of first coupling elements and/or their arrangement on the upper plate is predetermined depending on a number of occupied chip positions and/or their arrangement on the carrier plate for the low-side switch,
wherein the respective first coupling element is attached to the upper plate in such a way that it at least partially faces at least one connection of the respective semiconductor chip to which it is electrically coupled.

7. The voltage supply device according to claim 5,
wherein a source terminal of the at least one semiconductor chip of the low-side switch is connected via the at least one first coupling element and the at least part of the upper plate edge area to the at least part of the carrier plate edge area to which the at least part of the upper plate edge area is attached, and via the at least part of the carrier plate edge area with a negative pole of a power supply of the voltage supply device, and/or
wherein a drain terminal of the respective semiconductor chip of the high-side switch is electrically coupled via a first partial area of the carrier plate center area to a positive pole of the power supply of the voltage supply device.

8. The voltage supply device according to claim 5,
wherein at least one second coupling element is arranged in the volume space, which electrically couples a source terminal of the at least one semiconductor chip of the high-side switch with a second sub-area of the carrier plate center area, wherein the second sub-area is electrically coupled to a drain terminal of the at least one semiconductor chip of the low-side switch and to an output of the voltage supply device at which the output current can be provided.

9. A motor vehicle comprising:
the voltage supply device according to claim 1.

10. A method of manufacturing a voltage supply device according to claim 1, wherein the method comprises:
equipping the carrier plate with the at least one switchable semiconductor chip for the high-side switch and the low-side switch;
fastening to the carrier plate: drain terminals, gate terminals, and source terminals of terminal rows, of at least one second coupling element, connections at a negative pole, a positive pole and/or an output on the one hand and/or connecting elements between the gate terminal of the respective semiconductor chip and the gate terminal of the respective terminal row and between the source terminal of the respective semiconductor chip and the source terminal of the respective terminal row;
subsequently fastening the upper plate to the carrier plate to produce a carrier plate-upper plate component; and
overmolding and/or injection molding a housing around the carrier plate-upper plate component.
